(19) United States
(12) Patent Application Publication
(10) Pub. No.: US 2024/0396253 A1
(43) Pub. Date: Nov. 28, 2024

(54) POWER PLUG WITH THERMAL-INSULATION FUNCTION

(71) Applicant: ACBEL POLYTECH INC., New Taipei City (TW)

(72) Inventors: Chia-Hao LIN, New Taipei City (TW); Tse-Jung KUO, New Taipei City (TW); Min-Che TU, New Taipei City (TW)

(21) Appl. No.: 18/388,199

(22) Filed: Nov. 9, 2023

(30) Foreign Application Priority Data
May 25, 2023 (TW) 112205225

(51) Int. Cl. H01R 13/502

(52) U.S. Cl. CPC H01R 13/502

(57) ABSTRACT

A power plug with thermal insulation-function has an output connector having a wire connecting end, an internal module, a housing, and an external module. The internal module has an outer surface and encloses the wire connecting end of the output connector. A plurality of recesses are concavely formed on the outer surface of the internal module. The housing encloses the outer surface of the internal module, wherein a plurality of gas cells are formed between the housing and each of the plurality of recesses. The external module encloses the housing and the internal module. Air can be stored in the gas cells for insulating thermal conduction from inside to outside. Heat can hardly transfer from the internal module to the external module to dissipate via the outer surface of the external module, thereby lowering the surface temperature of the external module to avoid burning the user.

### BACKGROUND OF THE INVENTION

### 1. Field of the Invention

The invention is related to a power plug, more particularly to a power plug with thermal-insulation function.

### 2. Description of the Related Art

With the advance of science and technology, various electronic products have become multifunctional and performance of the products is thus enhanced. However, enhanced product performance raises demand for power supply. Therefore, electronic products related to power supply, e.g. power adapter, can no longer adopt old designs. A conventional power adapter usually focuses on heat dissipation between an inner part and a housing to comply with the touch temperature limits specified in UL 62368-1. However, an external module that encloses an output connector (direct current plug) is also a portion that would be touched by a user, so temperature at the external module needs to comply with UL62368-1 as well.

In the conventional power plugs, structures of the conventional power plugs are the same regardless of their output power. With reference to FIGS. 9, to manufacture said conventional power plug, a plurality wires 91 are fixed to an end of the output connector 90 by soldering, and a solder joint 92 is formed at each soldering position. Then, the wires 91 and the solder joints 92 are enclosed and secured by an internal module 93 made of a high-hardness material. After that, the internal module 93 is enclosed by an external module 94 made of a low-hardness material, such that the external module 94 would not shrink due to an uneven internal surface, avoiding negatively affecting the overall appearance.

However, in the foregoing arrangements, current outputs from the power adapter flow, via the wires 91 and the solder joints 92, then to the output connector 90. During the flow of currents, resistance of the solder joints 92, the output connector 90, and other components generate some heat accordingly. After the output connector 90 is plugged in a device, contact resistance is generated between the output connector 90 and a power jack (direct current jack), thereby generating heat. The heat inside the output connecter 90 transfers to a surface of the external module 94 through the internal module 93 and the external module 94. Nowadays, the conventional power plug with high output power, if adopting the abovementioned design, would have an overheating issue when the user touches the surface of the external module 94. Accordingly, the conventional power plugs need to be improved.

To overcome the shortcomings, the present invention provides a power plug to mitigate or obviate the aforementioned problems.

### SUMMARY OF THE INVENTION

The main objective of the present invention is to provide a power plug with thermal-insulation function, wherein an internal module has recesses in an outer surface thereof and is enclosed by a housing to form gas cells therebetween, thereby providing a thermal-insulation function.

To achieve the forgoing objective, the present invention provides a power plug with thermal-insulation function which comprises an output connector having a wire connecting end, an internal module, a housing, and an external module. The internal module has an outer surface and encloses the wire connecting end of the output connector. A plurality of recesses are concavely formed on the outer surface of the internal module. The housing encloses the outer surface of the internal module, wherein a plurality of gas cells are formed between the housing and each of the plurality of recesses. The external module encloses the housing and the internal module.

To achieve the forgoing objective, the present invention provides a power plug with thermal-insulation function which comprises an output connector having a wire connecting end, an internal module, a plurality of pieces of aerogels, and an external module. The internal module has an outer surface and encloses the wire connecting end of the output connector, wherein a plurality of recesses are concavely formed on the outer surface of the internal module. The plurality of pieces of aerogels are respectively filled into each of the plurality of recesses of the internal module. The external module encloses the internal module.

In an embodiment of the power plug with thermal-insulation function, the housing has a plurality of casings and a plurality of adhesive parts. An inner side surface of each of the casings is provided with one of the adhesive parts. Each of the casings is attached to the internal module via the adhesive part thereon to enclose the internal module.

In an embodiment, the housing has a plurality of casings, wherein each of the casings is provided with a plurality of engaging parts. The casings are engaged to enclose the internal module by engaging each of the engaging parts.

In an embodiment, a plurality of trenches are concavely formed on a surface of the housing and are arranged at intervals.

In an embodiment, each of the gas cells is filled with inert gas.

In an embodiment, the power plug with thermal-insulation function further comprises a plurality of rubber rings, wherein each of the rubber rings is sleeved around and mounted to an outer part of the housing, wherein each of the rubber rings is mounted at one of two ends of the housing.

The power plug in accordance with the present invention has the advantage that air can be retained and stored in the recesses covered by the housing due to the plurality of recesses formed on the outer surface of the internal module. As air is a natural thermal-insulation material, the power plug only needs to be slightly modified for effectively insulating thermal conduction from inside to outside. Heat can hardly be transferred from the internal module to the external module and dissipate through the outer surface of the external module, thereby lowering surface temperature of the external module to avoid burning the user. Internal heat can be dissipated through a socket or electrical wires.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view in partial section of a first embodiment of a power plug in accordance with the present invention;

FIG. 2 is an exploded perspective view of the power plug in FIG. 1, omitting an external module;

FIG. 3 is a perspective view of the power plug in FIG. 1;

FIG. 4 is a cross sectional side view of the power plug in FIG. 1;

FIG. 5 is an exploded perspective view of a second embodiment of a power plug in accordance with the present invention, omitting an external module;

FIG. 6 is an exploded perspective view of a third embodiment of a power plug in accordance with the present invention, omitting an external module;

FIG. 7 is an exploded perspective view of a fourth embodiment of a power plug in accordance with the present invention, omitting an external module;

FIG. 8 is an exploded perspective view of a fifth embodiment of a power plug in accordance with the present invention, omitting an external module; and

FIG. 9 is a perspective view of a conventional power plug.

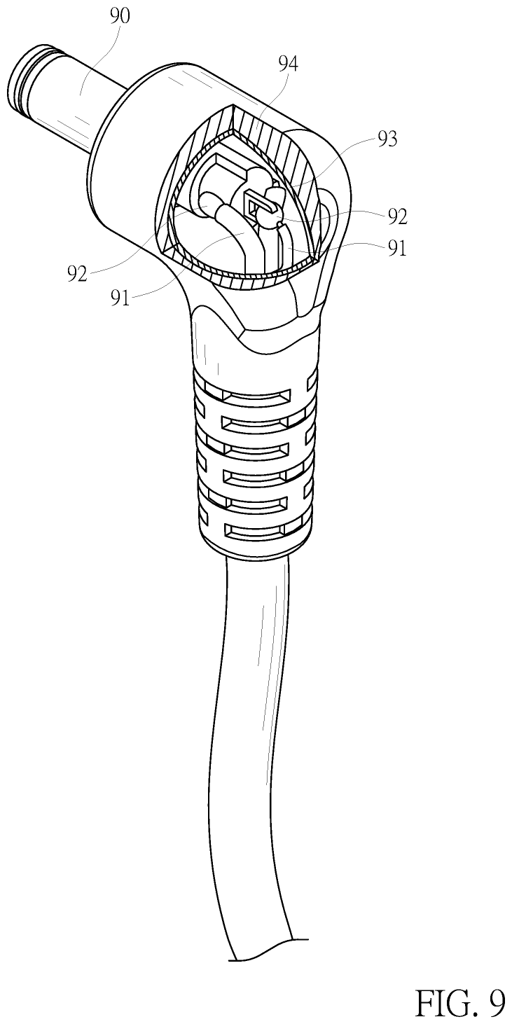

### DETAILED DESCRIPTION OF THE INVENTION

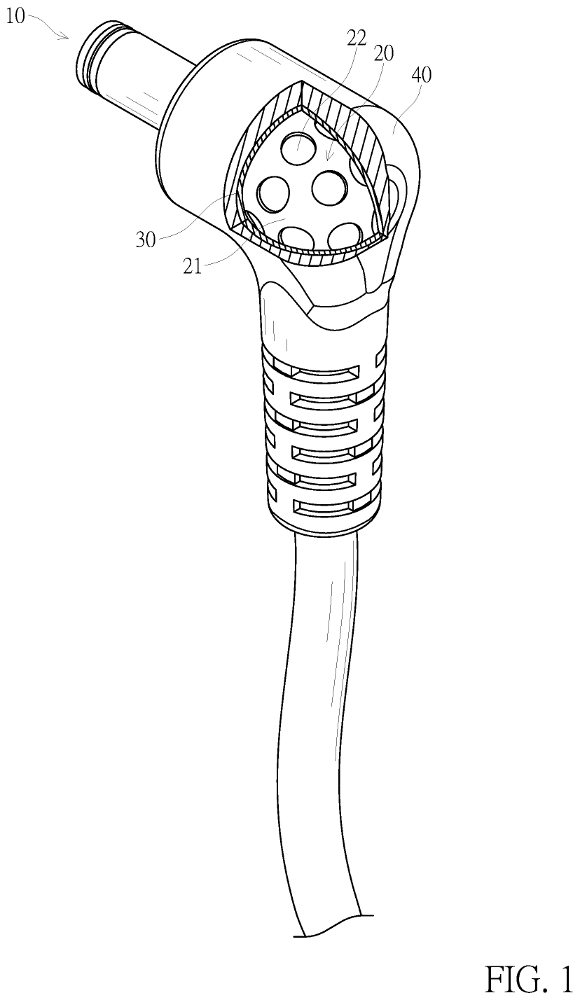

With reference to FIG. 1, a first embodiment of a power plug comprises an output connector 10, an internal module 20, a housing 30, and an external module 40.

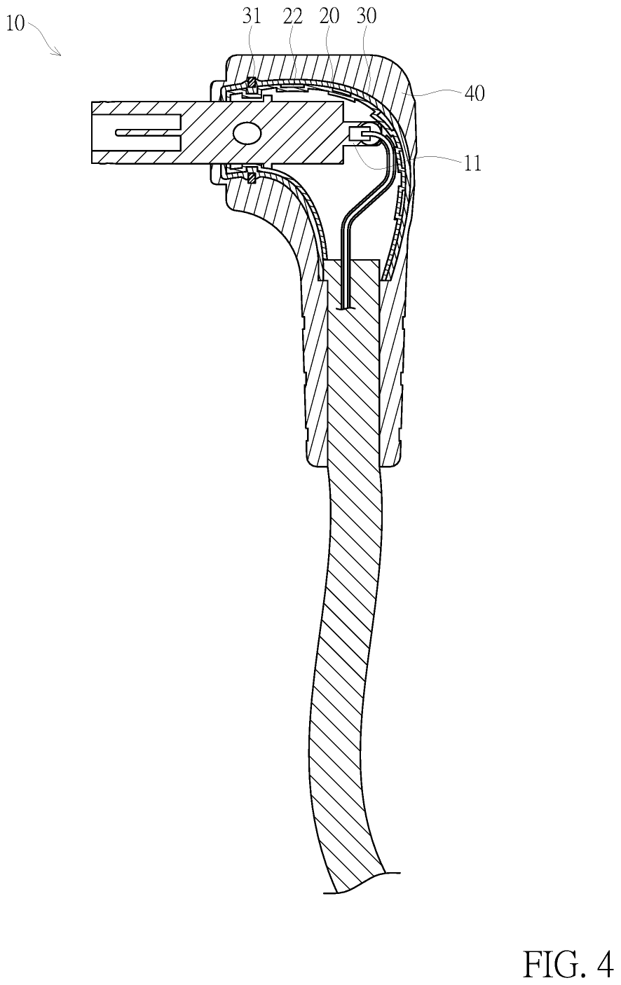

With reference to FIGS. 1 and 4, the output connector 10 may be a conventional electrical plug connected with a plurality of electrical wires, e.g. a direct current plug of a power adapter. The output connector 10 has a wire connecting end 11 at an end thereof, where the electrical wires are soldered to the electrical plug.

With reference to FIGS. 1, 2, and 4, the internal module 20 encloses the wire connecting end 11 of the output connector 10. The internal module 20 has an outer surface 21 facing away from the wire connecting end 11 and a plurality of recesses 22 concavely formed on the outer surface 21. The plurality of recesses 22 are arranged at intervals and are evenly distributed at the outer surface 21, but it is not limited thereto. Size and shape of each recess 22 may vary according to user's demand.

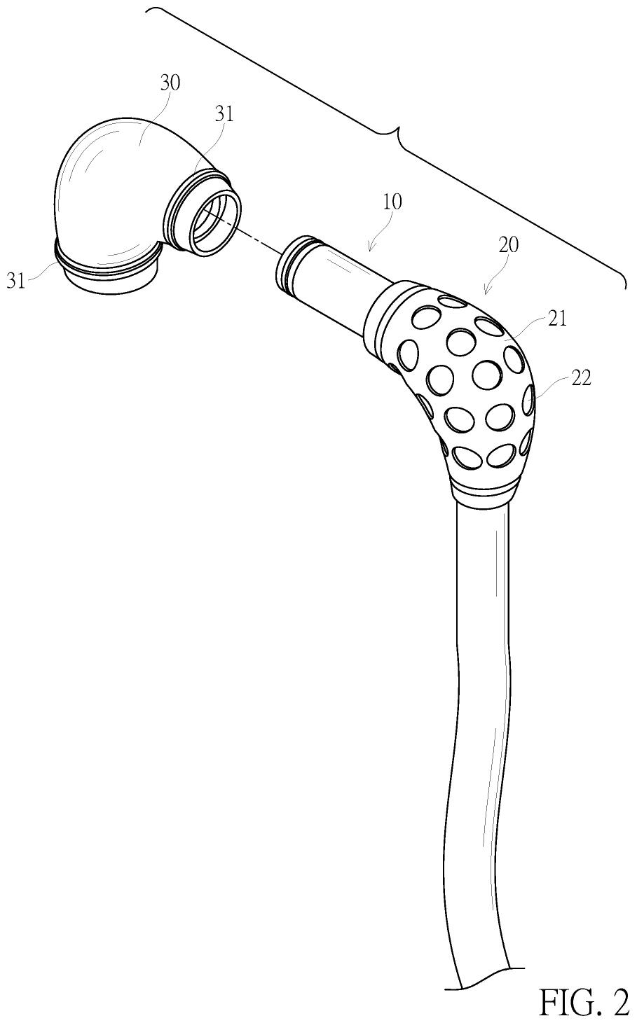

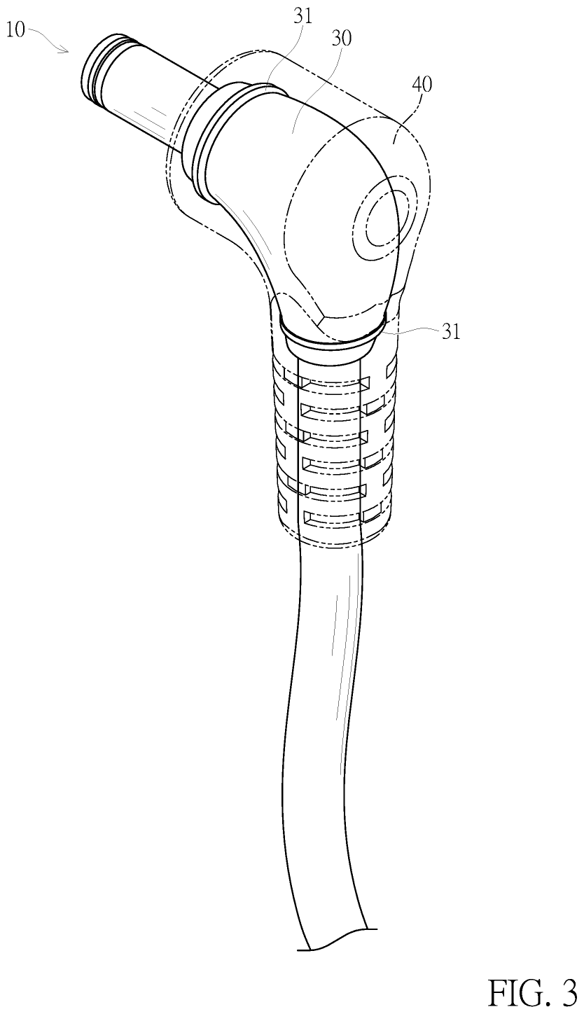

With reference to FIGS. 2 to 4, the housing 30 encloses the outer surface 21 of the internal module 20 to form a plurality of gas cells by the recesses 22 being covered by the housing 30. Specifically, the housing 30 may be made of a flexible material and may be a silicone sleeve or a shrinkable tubing to entirely enclose the internal module 20. The housing 30 can be considered as a cover covering each of the recesses 22 to seal each of the recesses 22 to form a respective closed gas cell. The closed gas cell may be filled with air, carbon dioxide (CO₂), inert gas, and so on, according to the user's need. In the first embodiment, a plurality of rubber rings 31 are sleeved around and mounted to an outer part of the housing 30 and are respectively adjacent to two ends of the outer part of the housing 30 to ensure that the housing 30 firmly covers the outer surface 21 of the internal module 20, but it is not limited thereto. The rubber rings 31 may be omitted.

The external module 40 encloses the housing 30. A shape of the external module 40 corresponds to a shape of the housing 30, but it is not limited thereto.

With reference to FIGS. 1 to 4, when the power plug is plugged into a power jack, because the plurality of recesses 22 are formed in the outer surface 21 of the internal module 20, air can be retained and stored in each recess 22 after the internal module 20 is enclosed by the housing 30. As air is a natural thermal-insulation material and has a high thermal resistance, without altering the existing structure too much, the power plug can effectively insulate thermal conduction from inside to outside. Heat can hardly transfer from the internal module 20 to the external module 40 to dissipate via the outer surface of the external module 40, thereby lowering the surface temperature of the external module 40 and avoiding burning the user. The internal temperature at the internal module 20 will rise, so the temperature difference between the internal shell 20 and the socket or the electrical wires is increased. The temperature gradient is increased because of the increasing temperature difference, and heat flux from the internal heat source to the socket and the electrical wires is increased for dissipating the internal heat to the socket and the electrical wires.

To fill up the gas cells with gas, after the internal module 20 is molded, the internal module 20 is placed into a box full of inert gas, and is enclosed by the housing 30 within the box. As the inert gas has a larger molecular mass than the air, the inert gas in the box will sink and is hard to dissipate from the box. The box is closed by a cover to ensure that the box contains the inert gas with a certain gas concentration.

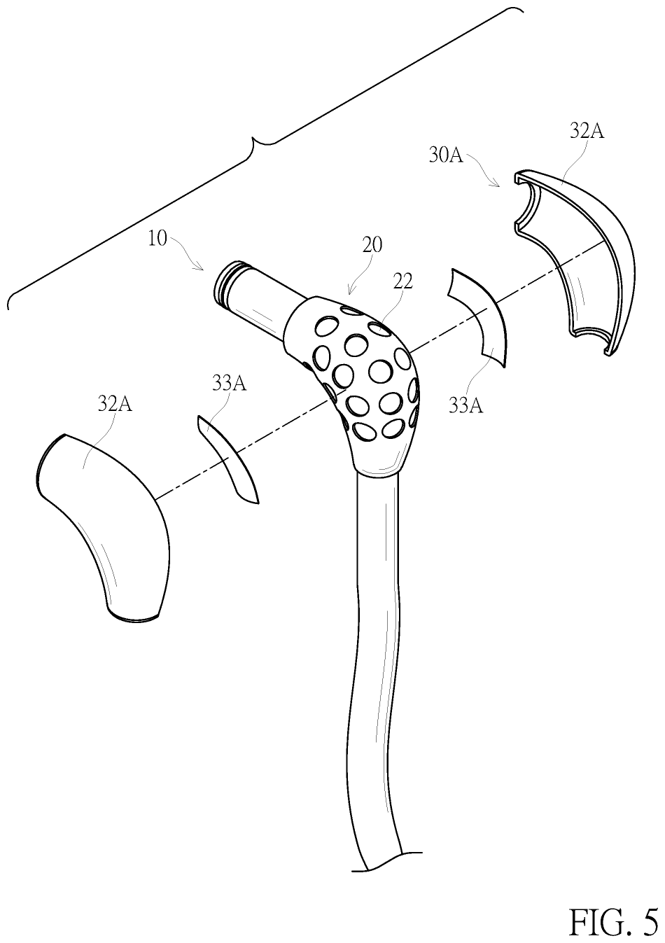

With reference to FIG. 5, in the second embodiment, the output connector 10, the internal module 20, and the external module (not shown in FIG. 5) are same as those in the first embodiment. The main difference between the second embodiment and the first embodiment is that the housing 30A has a plurality of casings 32A and a plurality of adhesive parts 33A. Each casing 32A corresponds to the internal module 20 in shape. Specifically, the casings 32A are attached to the internal module 20 via the adhesive parts 33A to form a housing enclosing the internal module 20. In the second embodiment, amounts of the casings 32A and of the adhesive parts 33A are each respectively, but not limited to, two.

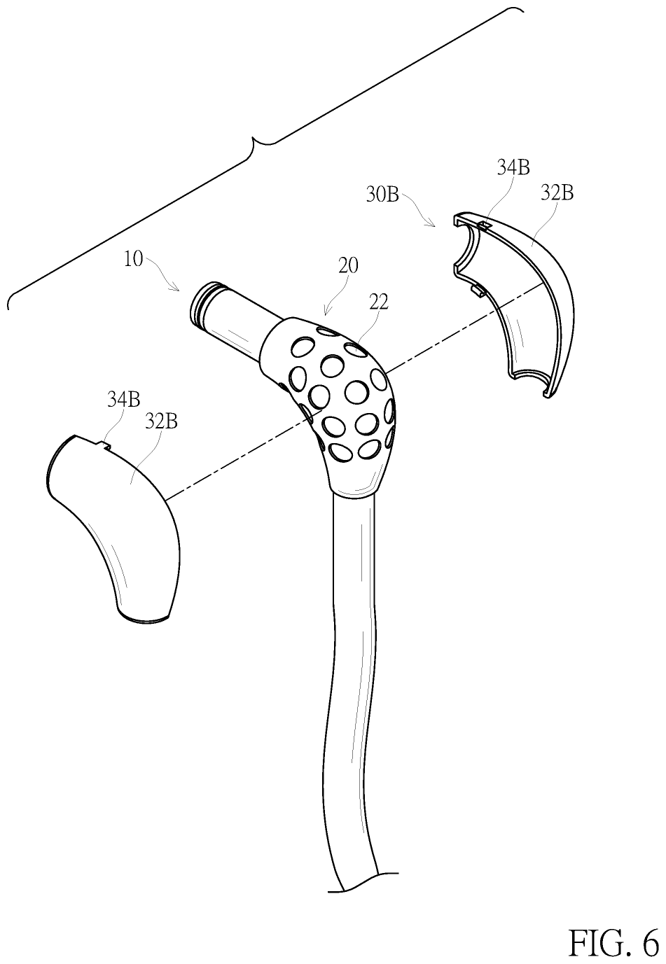

With reference to FIG. 6, in the third embodiment, the output connector 10, the internal module 20, and the external module (not shown in FIG. 6) are same as those in the second embodiment. The main difference between the third embodiment and the second embodiment is that each of the plurality of casings 32B of the housing 30B further has a plurality of engaging parts 34B formed thereon. The casings 32B are connected to one another via engagements between the engaging parts 34B and enclose the internal module 20. The engaging parts 34B may be conventional, so detailed structures thereof are omitted from description. Therefore, additional adhesive parts 33A for fixing the casings 32B are not necessary.

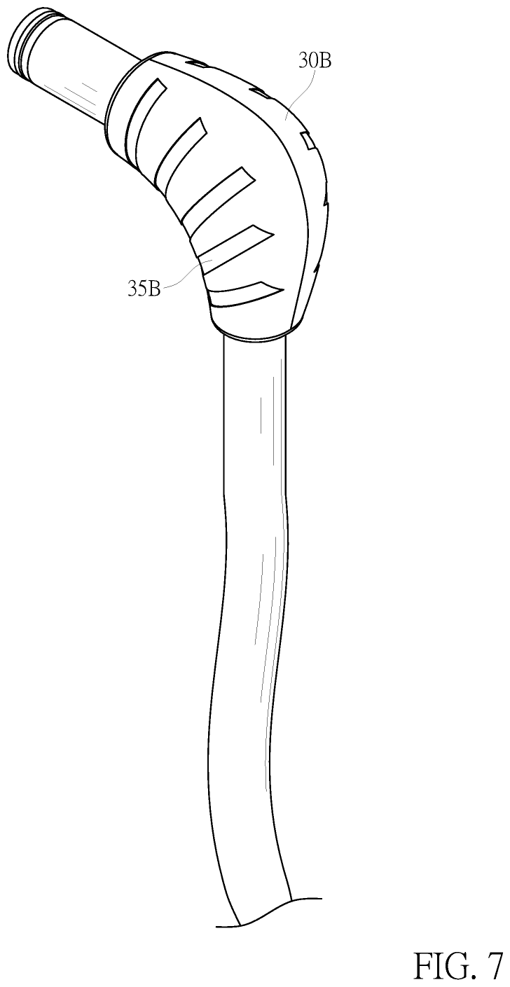

With reference to FIG. 7, in the fourth embodiment, the main difference between the fourth embodiment and the third embodiment is that the housing 30B further has a plurality of trenches 35B concavely formed on a surface of the housing 30B and arranged at intervals. Each trench 35B is elongated and spaced apart from one another, but it is not limited thereto. The arrangement and shapes of the trenches 35B may vary according to user's demand. The housing 30B with the plurality of trenches 35B is not limited to the housing 30B having casings, as it is also applicable for the housing 30 made of a flexible material.

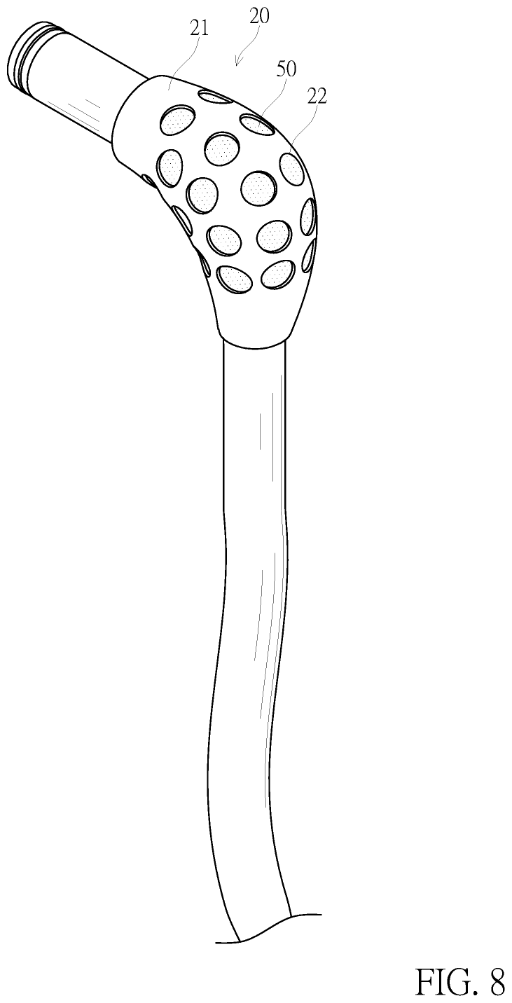

With reference to FIG. 8, in the fifth embodiment, the power plug comprises the output connector, the internal module 20, a plurality of pieces of aerogels 50, and the external module (not shown in FIG. 8). The main difference between the fifth embodiment and the first embodiment is that each recess 22 is filled up with aerogels 50. The aerogels 50 are respectively filled into each of the recesses 22 formed in the outer surface 21 of the internal module 20. The aerogels are porous gel material composed of a large amount of air, have extremely small thermal conductivity coefficient, and are conventional coating materials. After the aerogels 50 fill up the recesses 22, the aerogels 50 are dried off to solidify. Therefore, the external module can also directly enclose the internal module 20 without the housing for thermal insulation.

Even though numerous characteristics and advantages of the present invention have been set forth in the foregoing description, together with details of the structure and function of the invention, the disclosure is illustrative only. Changes may be made in detail, especially in matters of shape, size, and arrangement of parts within the principles of the invention to the full extent indicated by the broad general meaning of the terms in which the appended claims are expressed.

What is claimed is:

1. A power plug with thermal-insulation function, comprising:
an output connector having a wire connecting end;
an internal module having an outer surface and enclosing the wire connecting end of the output connector, wherein a plurality of recesses are concavely formed on the outer surface of the internal module;
a housing enclosing the outer surface of the internal module, wherein a plurality of gas cells are formed between the housing and each of the plurality of recesses; and
an external module enclosing the housing and the internal module.

2. The power plug with thermal-insulation function as claimed in claim 1, wherein
the housing has a plurality of casings and a plurality of adhesive parts;
an inner side surface of each of the casings is provided with one of the adhesive parts; and
each of the casings is attached to the internal module via the adhesive part thereon to enclose the internal module.

3. The power plug with thermal-insulation function as claimed in claim 1, wherein
the housing has a plurality of casings, and each of the casings is provided with a plurality of engaging parts; and
the casings are engaged to enclose the internal module by engaging each of the engaging parts.

4. The power plug with thermal-insulation function as claimed in claim 1, wherein a plurality of trenches are concavely formed on a surface of the housing and are arranged at intervals.

5. The power plug with thermal-insulation function as claimed in claim 2, wherein a plurality of trenches are concavely formed on a surface of the housing and are arranged at intervals.

6. The power plug with thermal-insulation function as claimed in claim 3, wherein a plurality of trenches are concavely formed on a surface of the housing and are arranged at intervals.

7. The power plug with thermal-insulation function as claimed in claim 4, wherein each of the gas cells is filled with inert gas.

8. The power plug with thermal-insulation function as claimed in claim 5, wherein each of the gas cells is filled with inert gas.

9. The power plug with thermal-insulation function as claimed in claim 6, wherein each of the gas cells is filled with inert gas.

10. The power plug with thermal-insulation function as claimed in claim 7 further comprising a plurality of rubber rings, wherein each of the rubber rings is sleeved around and mounted to an outer part of the housing, wherein each of the rubber rings is mounted at one of two ends of the housing.

11. The power plug with thermal-insulation function as claimed in claim 8 further comprising a plurality of rubber rings, wherein each of the rubber rings is sleeved around and mounted to an outer part of the housing, wherein each of the rubber rings is mounted at one of two ends of the housing.

12. The power plug with thermal-insulation function as claimed in claim 9 further comprising a plurality of rubber rings, wherein each of the rubber rings is sleeved around and mounted to an outer part of the housing, wherein each of the rubber rings is mounted at one of two ends of the housing.

13. A power plug with thermal-insulation function comprising:
an output connector having
a wire connecting end;
an internal module having an outer surface and enclosing the wire connecting end of the output connector, wherein a plurality of recesses are concavely formed on the outer surface of the internal module;
a plurality of pieces of aerogels respectively filled into each of the plurality of recesses of the internal module; and
an external module enclosing the internal module.
